(19) United States
(12) Patent Application Publication
(10) Pub. No.: US 2017/0276847 A1
(43) Pub. Date: Sep. 28, 2017

(54) IMAGING SYSTEM

(71) Applicant: OLYMPUS CORPORATION, Tokyo (JP)

(72) Inventors: Kazunori YOSHIZAKI, Tokyo (JP); Ken IOKA, Tokyo (JP); Sunao KIKUCHI, Tokyo (JP); Yasuhiro KOMIYA, Sagamihara-shi (JP); Yasuhiro FUKUNAGA, Tokyo (JP)

(73) Assignee: OLYMPUS CORPORATION, Tokyo (JP)

(21) Appl. No.: 15/622,031

(22) Filed: Jun. 13, 2017

Related U.S. Application Data
(63) Continuation of application No. PCT/JP2014/083179, filed on Dec. 15, 2014.

(51) Int. Cl. G02B 5/28; G02F 1/01

(52) U.S. Cl. CPC G02B 5/281; G02F 1/0105; G02F 1/133524

(57) ABSTRACT

An imaging system includes: an imaging sensor; a plurality of first band filters and a second band filter, the second band filter being configured to transmit narrowband light having a maximum value of a transmission spectrum outside a range of a wavelength band of light that passes through the first band filter; and a light source unit configured to radiate light having a projecting distribution in which at least one of an upper limit value and a lower limit value of a wavelength that are half a maximum value in a light spectrum of a light source is between an upper limit value and a lower limit value of a wavelength that are half the maximum value in the transmission spectrum of the second band filter. A color and a narrowband images are generated from a single image while the light source unit radiates the light.

### CROSS REFERENCES TO RELATED APPLICATIONS

This application is a continuation of PCT international application Ser. No. PCT/JP2014/083179 filed on Dec. 15, 2014, which designates the United States, incorporated herein by reference.

### BACKGROUND

The present invention relates to an imaging system.

In recent years, a technique of simultaneously acquiring a narrowband image and a colored normal image has been known in the field of endoscopes (refer to JP 5191090 B1). Specifically, a plurality of broadband filters characterized by transmission of broadband wavelengths in a visible region and a plurality of narrowband filters characterized by transmission of narrowband wavelengths are arrayed in a grid pattern to form a filter unit, and the filter unit is provided in an imaging sensor. Capillaries in a superficial portion of a mucous membrane and a fine pattern of the mucous membrane can be observed in the narrowband image.

### SUMMARY

An imaging system according to one aspect of the present disclosure includes: an imaging sensor configured to perform a photoelectric conversion on light received by each of a plurality of pixels arranged in a grid pattern to generate an electric signal; a color filter in which a filter unit including a plurality of first band filters and a second band filter is arranged in association with the plurality of pixels, each of the first band filters being configured to transmit light in a wavelength band of a primary color or a complementary color, the second band filter being configured to transmit narrowband light having a maximum value of a transmission spectrum outside a range of the wavelength band of the light that passes through the first band filter; and a light source unit configured to radiate light having a projecting distribution in which at least one of an upper limit value and a lower limit value of a wavelength that are half a maximum value in a light spectrum of a light source is between an upper limit value and a lower limit value of a wavelength that are half the maximum value in the transmission spectrum of the second band filter, wherein both a color image and a narrowband image are generated from a single image corresponding to the electric signal captured and output by the imaging sensor while the light source unit radiates the light.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating an overview configuration of a capsule endoscope system according to a first embodiment of the present invention;

FIG. 2 is a block diagram illustrating a functional configuration of a capsule endoscope according to the first embodiment of the present invention;

FIG. 3 is a diagram schematically illustrating a configuration of a color filter according to the first embodiment of the present invention;

FIG. 4 is a diagram illustrating the relation between transmittance of each filter that constitutes the color filter and intensity of light radiated by a light source unit according to the first embodiment of the present invention;

FIG. 5 is a diagram schematically illustrating a configuration of a light source unit according to a second embodiment of the present invention;

FIG. 6 is a diagram illustrating the relation between transmittance of each filter that constitutes a color filter and intensity of light radiated by the light source unit according to the second embodiment of the present invention;

FIG. 7 is a schematic diagram illustrating a configuration of a light source unit according to a variation of the second embodiment of the present invention;

FIG. 8 is a diagram schematically illustrating a configuration of a color filter according to a third embodiment of the present invention;

FIG. 9 is a schematic diagram illustrating a configuration of a light source unit according to the third embodiment of the present invention; and

FIG. 10 is a diagram illustrating the relation between transmittance of each filter that constitutes the color filter and intensity of light radiated by the light source unit according to the third embodiment of the present invention.

### DETAILED DESCRIPTION

Hereinafter, modes for carrying out the present invention will be described in detail with reference to the drawings. The present invention is not limited by the following embodiments. In each drawing that is referred to in the following description, a shape, a size, and a positional relation are only schematically illustrated to such an extent that contents of the present invention can be understood. Therefore, the present invention is not limited only to the shape, the size, and the positional relation represented in each drawing. The following description is based on an example of a capsule endoscope system including a capsule endoscope that is introduced into a subject to capture an in-vivo image of the subject and a processing device that receives a wireless signal from the capsule endoscope to display the in-vivo image of the subject. However, the present invention is not limited by this embodiment. Identical components are denoted by the same reference signs for illustration.

### First Embodiment

Schematic Configuration of Capsule Endoscope System

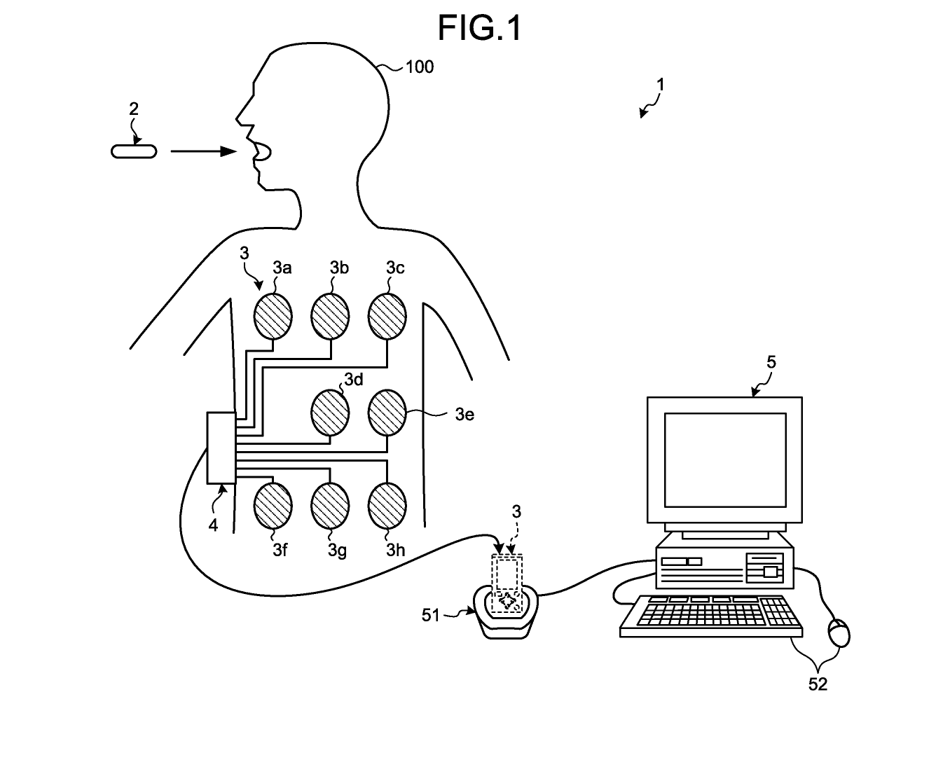

FIG. 1 is a schematic diagram illustrating an overview configuration of a capsule endoscope system according to a first embodiment of the present invention.

A capsule endoscope system 1 illustrated in FIG. 1 includes a capsule endoscope 2, a receiving antenna unit 3, a receiving device 4, and an image processing device 5. The capsule endoscope 2 captures an in-vivo image of a subject 100. The receiving antenna unit 3 receives a wireless signal sent from the capsule endoscope 2 introduced into the subject 100. The receiving antenna unit 3 is detachably connected to the receiving device 4. The receiving device 4 performs a predetermined process on the wireless signal received by the receiving antenna unit 3 for recording and display. The image processing device 5 processes and/or displays an image corresponding to image data of the inside of the subject 100 captured by the capsule endoscope 2.

The capsule endoscope 2 has an imaging function of capturing the inside of the subject 100 and a wireless communication function of sending, to the receiving antenna unit 3, in-vivo information including the image data obtained by capturing the inside of the subject 100. The capsule endoscope 2 is swallowed into the subject 100 to pass through an esophagus in the subject 100 and move through a body cavity of the subject 100 with the aid of a peristaltic movement of a digestive lumen. The capsule endoscope 2 sequentially captures the inside of the body cavity of the subject 100 at very small time intervals, for example, at intervals of 0.5 seconds (2 fps), while moving through the body cavity of the subject 100. The capsule endoscope 2 then generates pieces of image data of the inside of the subject 100 captured, and sequentially sends the pieces of image data to the receiving antenna unit 3. A detailed configuration of the capsule endoscope 2 will be described later.

The receiving antenna unit 3 includes receiving antennas 3a to 3h. Each of the receiving antennas 3a to 3h receives the wireless signal from the capsule endoscope 2 and sends the wireless signal to the receiving device 4. Each of the receiving antennas 3a to 3h is configured with the use of a loop antenna and arranged at a predetermined position on an outer surface of the subject 100, for example, at a position corresponding to each organ in the subject 100 through which the capsule endoscope 2 passes.

The receiving device 4 records the image data of the inside of the subject 100 included in the wireless signal sent from the capsule endoscope 2 through the receiving antennas 3a to 3h, or displays the image corresponding to the image data of the inside of the subject 100. The receiving device 4 records, for example, positional information of the capsule endoscope 2 and time information indicating time in association with the image data received through the receiving antennas 3a to 3h. The receiving device 4 is contained in a receiving device holder (not illustrated) and carried by the subject 100 while an examination is performed using the capsule endoscope 2, for example, while the capsule endoscope 2 is introduced through a mouth of the subject 100, passes through a digestive tract, and is discharged from the subject 100. The receiving device 4 is removed from the subject 100 after the end of the examination with the capsule endoscope 2, and connected to the image processing device 5 for transferring the image data or the like received from the capsule endoscope 2.

The image processing device 5 displays the image corresponding to the image data of the inside of the subject 100 acquired through the receiving device 4. The image processing device 5 includes a cradle 51 that reads the image data or the like from the receiving device 4 and an operation input device 52 such as a keyboard and a mouse. When the receiving device 4 is attached, the cradle 51 acquires, from the receiving device 4, the image data and related information associated with the image data such as the positional information, the time information, and identification information of the capsule endoscope 2. The cradle 51 then transfers the acquired items of information to the image processing device 5. The operation input device 52 accepts input from a user. The user makes a diagnosis for the subject 100 by observing a body part inside the subject 100, e.g., an esophagus, a stomach, a small intestine, and a large intestine, while operating the operation input device 52 and watching the images of the inside of the subject 100 sequentially displayed by the image processing device 5.

Configuration of Capsule Endoscope

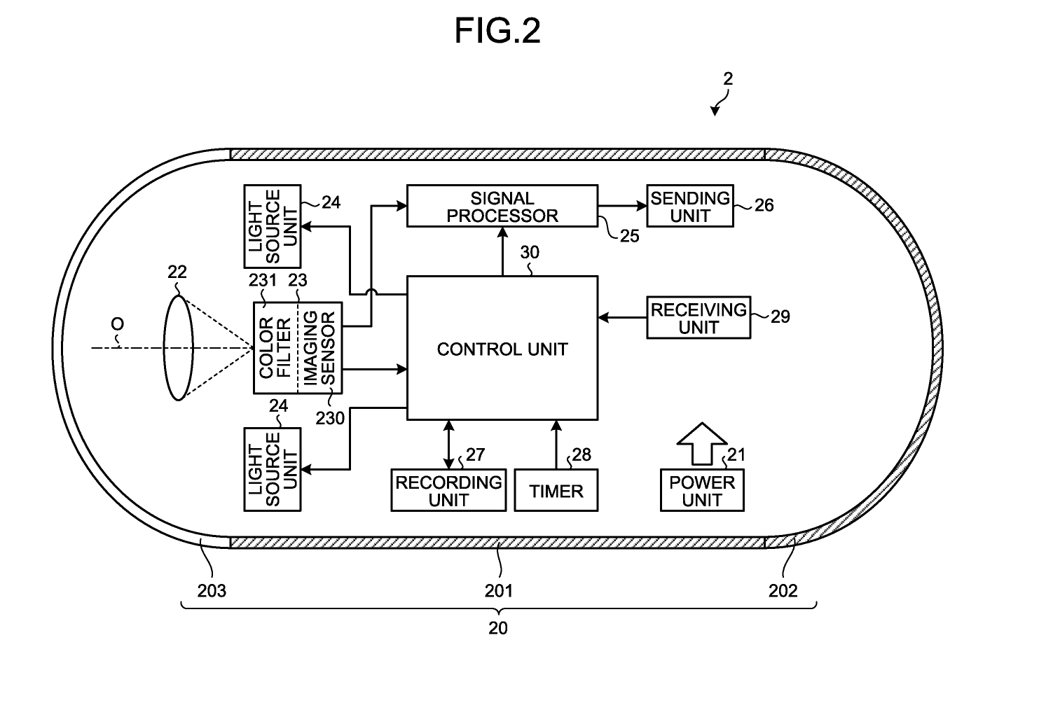

Next, the detailed configuration of the capsule endoscope 2 described in FIG. 1 will be described. FIG. 2 is a block diagram illustrating a functional configuration of the capsule endoscope 2.

The capsule endoscope 2 illustrated in FIG. 2 has a casing 20, a power unit 21, an optical system 22, an imaging unit 23, a light source unit 24, a signal processor 25, a sending unit 26, a recording unit 27, a timer 28, a receiving unit 29, and a control unit 30.

The casing 20 has a capsule shape formed to have such a size as to allow itself to be easily introduced into the subject 100. The casing 20 has a cylindrical tube portion 201 and dome-shaped dome portions 202 and 203. The dome portions 202 and 203 cover both opening ends of the tube portion 201. Each of the tube portion 201 and the dome portion 202 is formed with the use of an opaque colored member that blocks visible light. The dome portion 203 is configured with the use of an optical member capable of transmitting light in a predetermined wavelength band such as visible light. The casing 20 formed of the tube portion 201 and the dome portions 202 and 203 contains the power unit 21, the optical system 22, the imaging unit 23, the light source unit 24, the signal processor 25, the sending unit 26, the recording unit 27, the timer 28, the receiving unit 29, and the control unit 30 as illustrated in FIG. 2.

The power unit 21 supplies power to each component in the capsule endoscope 2. The power unit 21 is configured with the use of a primary battery or a secondary battery such as a button battery and a power circuit that boosts the electric power supplied from the button battery. The power unit 21 has a magnetic switch and switches an on/off state of the power by means of a magnetic field applied from the outside.

The optical system 22 is configured with the use of a plurality of lenses. The optical system 22 collects reflected light of illumination light radiated by the light source unit 24 at an imaging surface of the imaging unit 23, and forms an object image. The optical system 22 is arranged in the casing 20 so that an optical axis coincides with a central axis O in a longitudinal direction of the casing 20.

Under the control of the control unit 30, the imaging unit 23 receives the object image formed at the light receiving surface by the optical system 22 and performs a photoelectric conversion, thereby generating the image data of the subject 100. More specifically, under the control of the control unit 30, the imaging unit 23 captures the subject 100 at a reference frame rate, for example, at a frame rate of 4 fps, and generates the image data of the subject 100. The imaging unit 23 is configured with the use of an imaging sensor 230 such as a charge coupled device (CCD) and a complementary metal oxide semiconductor (CMOS) and a color filter 231. The imaging sensor 230 performs the photoelectric conversion on light received by each of a plurality of pixels arranged in a grid pattern to generate an electric signal. In the color filter 231, a filter unit including a plurality of first band filters (hereinafter referred to as “broadband filters”) and a second band filter (hereinafter referred to as a “narrowband filter”) is arranged in association with the plurality of pixels. Each of the first band filters transmits light in a wavelength band of a primary color or a complementary color. The second band filter transmits narrowband light having a maximum value outside the range of the wavelength band of the light that passes through the first band filter.

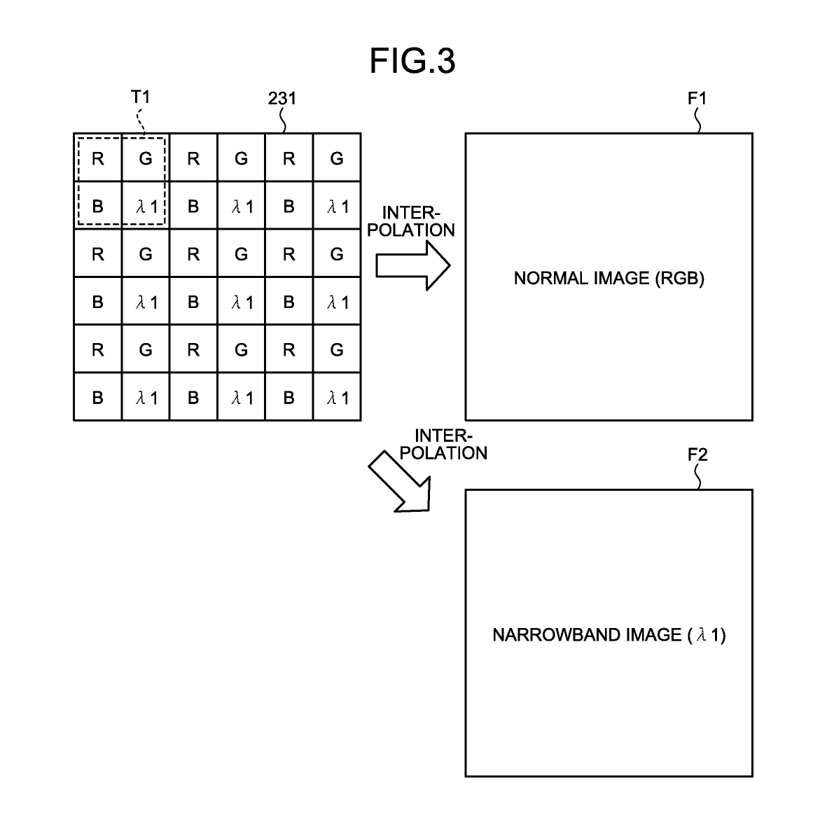

FIG. 3 is a diagram schematically illustrating a configuration of the color filter 231. As illustrated in FIG. 3, the color filter 231 is configured with the use of the filter unit including a set of arrayed filters T1, that is, a broadband filter R that transmits a red component, a broadband filter G that transmits a green component, a broadband filter B that transmits a blue component, and a narrowband filter λ1 that transmits narrowband light having a maximum value of a transmission spectrum outside the range of the wavelength band of the light that passes through each of the broadband filters. As used herein, the wavelength band of the narrowband light in the first embodiment is 415 nm±20 nm. The image data generated by the imaging unit 23 using the color filter 231 configured as above are subjected to a predetermined image process (e.g., interpolation such as a demosaicing process) by the receiving device 4 or the image processing device 5, and thus converted into a colored normal image F1 and a narrowband image F2. Transmittance of each filter of the color filter 231 will be described later in detail.

Under the control of the control unit 30, the light source unit 24 radiates light to the object within an imaging field of the imaging unit 23 in synchronization with the frame rate of the imaging unit 23. More specifically, the light source unit 24 radiates such light having a projecting distribution that at least one of an upper limit value and a lower limit value of a wavelength that are half a maximum value in a light spectrum of a light source is between an upper limit value and a lower limit value of a wavelength that are half a maximum value in the transmission spectrum of the narrowband filter. The light source unit 24 is configured with the use of, for example, a light emitting diode (LED) light source that emits light in a predetermined wavelength band, a phosphor that is excited by the light emitted by the LED light source, and a drive circuit. Intensity of the light radiated by the light source unit 24 will be described later in detail.

The signal processor 25 performs a predetermined image process on the image data input from the imaging unit 23, and outputs the image data to the sending unit 26. As used herein, the predetermined image process is a noise reduction process and a gain-up process or the like.

The sending unit 26 wirelessly sends, to the outside, the pieces of image data sequentially input from the signal processor 25. The sending unit 26 is configured with the use of a sending antenna and a modulation circuit that performs a signal process such as a modulation on the image data and modulates the image data into a wireless signal.

The recording unit 27 records, for example, programs indicating various operations that are executed by the capsule endoscope 2 and identification information for identifying the capsule endoscope 2.

The timer 28 has a time measuring function. The timer 28 outputs time measuring data to the control unit 30.

The receiving unit 29 receives a wireless signal sent from the outside and outputs the wireless signal to the control unit 30. The receiving unit 29 is configured with the use of a receiving antenna and a demodulation circuit that performs a signal process such as a demodulation on the wireless signal and outputs the demodulated signal to the control unit 30.

The control unit 30 controls the operation of each component of the capsule endoscope 2. The control unit 30 is configured with the use of a central processing unit (CPU).

The capsule endoscope 2 configured as above successively captures the inside of the body cavity of the subject 100 at very small time intervals while moving through the body cavity of the subject 100. The capsule endoscope 2 then generates the pieces of image data of the inside of the subject 100 captured, and sequentially sends the pieces of image data to the receiving antenna unit 3.

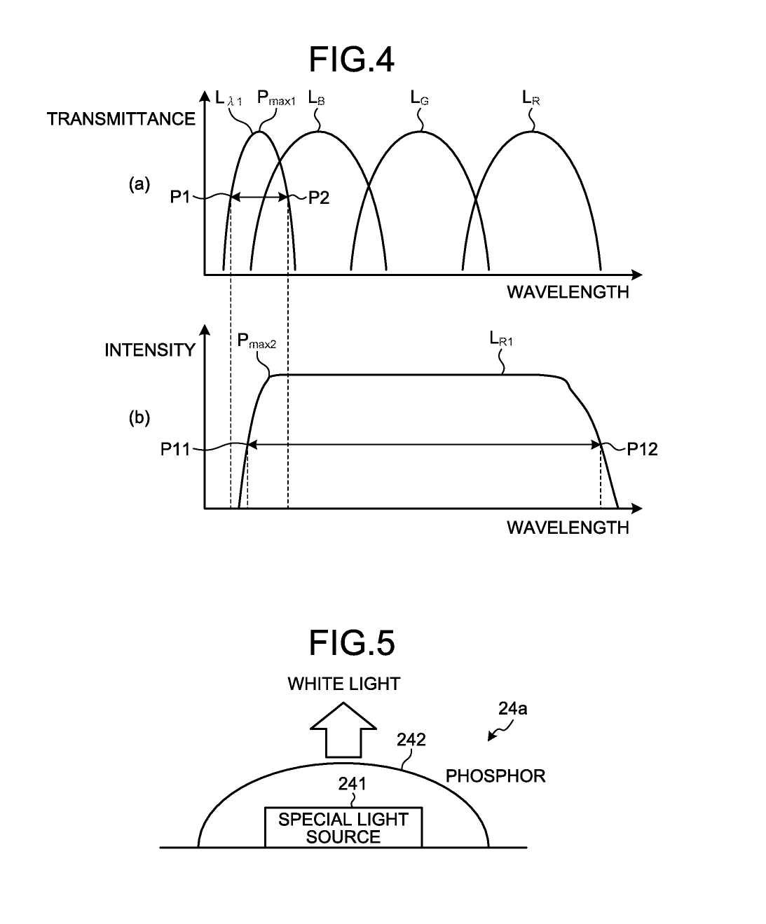

Next, the relation between the transmittance of each filter that constitutes the above-mentioned color filter 231 and the intensity of the light radiated by the light source unit 24 will be described. FIG. 4 is a diagram illustrating the relation between the transmittance of each filter that constitutes the color filter 231 and the intensity of the light radiated by the light source unit 24. In FIG. 4, FIG. 4(a) illustrates the relation between the transmittance and the wavelength of each filter that constitutes the color filter 231, and FIG. 4(b) illustrates the relation between the wavelength and the intensity of the light spectrum radiated by the light source unit 24. In FIG. 4(a), a curve L_{B} illustrates the relation between the transmittance and the wavelength of the filter B, a curve L_{G} illustrates the relation between the transmittance and the wavelength of the filter G, a curve L_{R} illustrates the relation between the transmittance and the wavelength of the filter R, and a curve L_{λ1} illustrates the relation between the transmittance and the wavelength of the narrowband filter λ1. Moreover, in FIG. 4(b), a curve L_{R1} illustrates the relation between the intensity and the wavelength of the light radiated by the light source unit 24. The description of FIG. 4 is based on the assumption that the peak wavelength for the narrowband filter λ1 is 415 nm±30 nm.

As illustrated by the curve L_{R1} in FIG. 4, the light source unit 24 radiates such light having the projecting distribution that at least one of an upper limit value P12 and a lower limit value P11 of the wavelength that are half a maximum value Pₘₐₓ₂ in the light spectrum of the light source is between a lower limit value P1 and an upper limit value P2 of the wavelength that are half a maximum value Pₘₐₓ₁ in the transmission spectrum of the narrowband filter λ1. More specifically, the light source unit 24 radiates such light that the lower limit value P11 of the wavelength that is half the maximum value Pₘₐₓ₂ in the light spectrum of the light source is between the lower limit value P1 and the upper limit value P2 of the wavelength that are half the maximum value Pₘₐₓ₁ in the transmission spectrum of the narrowband filter λ1.

The light radiated by the light source unit 24 in this manner is reflected at the object and received by the imaging sensor 230 through the optical system 22 and the color filter 231. The electric signal (image information) subjected to the photoelectric conversion in the imaging sensor 230 undergoes the predetermined image process in the receiving device 4 or the image processing device 5, whereby the normal image F1 (refer to FIG. 3) and the narrowband image F2 (refer to FIG. 3) can be obtained.

According to the above-described first embodiment, the light source unit 24 radiates such light having the projecting distribution that at least one of the upper limit value and the lower limit value of the wavelength that are half the maximum value in the light spectrum of the light source is between the upper limit value and the lower limit value of the wavelength that are half the maximum value in the transmission spectrum of the narrowband filter λ1. Therefore, the high-quality narrowband image can be obtained.

In addition, according to the first embodiment, images free from position misalignment can be obtained since the normal image and the narrowband image can be simultaneously acquired.

Furthermore, according to the first embodiment, an image process for aligning the images can be omitted when the normal image and the narrowband image are superimposed since the normal image and the narrowband image can be simultaneously acquired.

### Second Embodiment

Next, a second embodiment of the present invention will be described. A difference between the second embodiment and the above-mentioned first embodiment is only the configuration of the light source unit. Hereinafter, therefore, the configuration of the light source unit according to the second embodiment will be described. Components that are identical to those of the above-mentioned first embodiment are denoted by the same reference signs, and descriptions thereof are omitted.

FIG. 5 is a diagram schematically illustrating the configuration of the light source unit according to the second embodiment. A light source unit 24a illustrated in FIG. 5 has a special light source 241 and a phosphor 242. The special light source 241 emits light having a narrow spectrum with a maximum value of 415 nm. The phosphor 242 is exposed to and excited by the light radiated by the special light source 241. The special light source 241 and the phosphor 242 are configured as a single light source module. The special light source 241 is configured with the use of an LED light source.

The light source unit 24a configured as above radiates light including such first light that an upper limit value and a lower limit value of a wavelength that are half a maximum value in a light spectrum of the special light source 241 are between the lower limit value and the upper limit value of the wavelength that are half the maximum value in the transmission spectrum of the narrowband filter λ1 and second light having a maximum value (peak wavelength) of a light spectrum in a wavelength band different from the maximum value in the transmission spectrum that passes through the narrowband filter λ1.

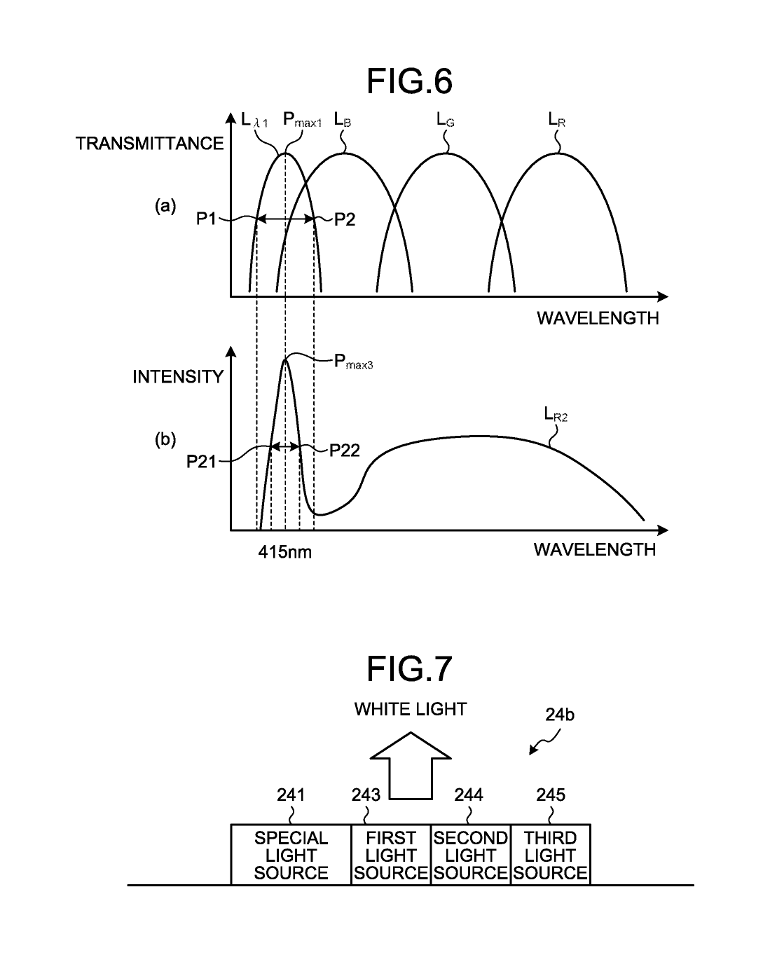

Next, the relation between the transmittance of each filter that constitutes the color filter 231 and intensity of the light radiated by the light source unit 24a will be described. FIG. 6 is a diagram illustrating the relation between the transmittance of each filter that constitutes the color filter 231 and the intensity of the light radiated by the light source unit 24a. In FIG. 6, FIG. 6(a) illustrates the relation between the transmittance and the wavelength of each filter that constitutes the color filter 231, and FIG. 6(b) illustrates the relation between the wavelength and the intensity of the light spectrum radiated by the light source unit 24a. In FIG. 6(a), the curve L_{B} illustrates the relation between the transmittance and the wavelength of the filter B, the curve L_{G} illustrates the relation between the transmittance and the wavelength of the filter G, the curve L_{R} illustrates the relation between the transmittance and the wavelength of the filter R, and the curve L_{λ1} illustrates the relation between the transmittance and the wavelength of the narrowband filter λ1. Moreover, in FIG. 4(b), a curve L_{R2} illustrates the relation between the intensity and the wavelength of the light radiated by the light source unit 24a.

As illustrated by the curve L_{R2} in FIG. 6, the light source unit 24a radiates such first light that a lower limit value P21 and an upper limit value P22 of the wavelength that are half a maximum value Pₘₐₓ₃ in the light spectrum of the light radiated by the light source unit 24a are between the lower limit value P1 and the upper limit value P2 of the wavelength that are half the maximum value Pₘₐₓ₁ in the transmission spectrum of the narrowband filter λ1. More specifically, the light source unit 24a radiates such first light that both the lower limit value P21 and the upper limit value P22 of the wavelength that are half the maximum value Pₘₐₓ₃ in the light spectrum are between the lower limit value P1 and the upper limit value P2 of the wavelength that are half the maximum value Pₘₐₓ₁ in the transmission spectrum of the narrowband filter λ1. Moreover, the light source unit 24a radiates such first light that the maximum value Pₘₐₓ₃ of the narrow spectrum emitted by the special light source 241 of the light source unit 24a coincides with the maximum value Pₘₐₓ₁ of the transmission spectrum of the narrowband filter λ1. Furthermore, as illustrated by the curve L_{R2}, the light source unit 24a radiates the second light having the maximum value (peak wavelength) of the light spectrum in a wavelength band different from the maximum value Pₘₐₓ₁ of the transmission spectrum that passes through the narrowband filter λ1. More specifically, the light source unit 24a radiates the second light having the maximum value of the light spectrum outside the full width at half maximum of the transmission spectrum of the narrowband filter λ1.

According to the above-described second embodiment, the light source unit 24a radiates the light including such first light that the upper limit value and the lower limit value of the wavelength that are half the maximum value in the light spectrum are between the lower limit value and the upper limit value of the wavelength that are half the maximum value in the transmission spectrum of the narrowband filter λ1 and the second light having the maximum value of the light spectrum in the wavelength band different from the maximum value in the transmission spectrum that passes through the narrowband filter λ1. Therefore, the high-quality narrowband image can be obtained.

In addition, according to the second embodiment, the light source unit 24a radiates such first light that the maximum value Pₘₐₓ₃ of the narrow spectrum emitted by the special light source 241 coincides with the maximum value Pₘₐₓ₁ of the transmission spectrum of the narrowband filter λ1. Therefore, the narrowband image of higher quality can be acquired.

Moreover, according to the second embodiment, power consumption is outstandingly low since only the special light source 241 emits the light.

Furthermore, according to the second embodiment, the light source unit 24a can be reduced in size since the special light source 241 and the phosphor 242 are configured as a single light source module.

### Variation of Second Embodiment

FIG. 7 is a schematic diagram illustrating a configuration of a light source unit according to a variation of the second embodiment. A light source unit 24b illustrated in FIG. 7 has the special light source 241, a first light source 243, a second light source 244, and a third light source 245.

The first light source 243 is configured with the use of an LED that emits broadband light having a red wavelength band (red LED). The second light source 244 is configured with the use of an LED that emits broadband light having a green wavelength band (green LED). The third light source 245 is configured with the use of an LED that emits broadband light having a blue wavelength band (blue LED). The special light source 241, the first light source 243, the second light source 244, and the third light source 245 are configured as a single module.

Under the control of the control unit 30, the light source unit 24b configured as above radiates the light including such first light that the upper limit value and the lower limit value of the wavelength that are half the maximum value in the light spectrum of the special light source 241 are between the lower limit value and the upper limit value of the wavelength that are half the maximum value in the transmission spectrum of the narrowband filter λ1 and the second light having the maximum value of the light spectrum in the wavelength band different from the maximum value in the transmission spectrum that passes through the narrowband filter λ1. More specifically, the light source unit 24b causes the special light source 241, the first light source 243, the second light source 244, and the third light source 245 to emit beams of light simultaneously under the control of the control unit 30.

According to the above-described variation of the second embodiment, an effect similar to that of the above-mentioned second embodiment can be obtained.

Furthermore, according to the variation of the second embodiment, the light source unit 24b can be reduced in size since the special light source 241, the first light source 243, the second light source 244, and the third light source 245 are configured as a single module.

### Third Embodiment

Next, a third embodiment of the present invention will be described. Configurations of a color filter and a light source unit of the third embodiment are different from those of the above-mentioned first embodiment. Hereinafter, therefore, the configurations of the color filter and the light source unit according to the third embodiment will be described. Components that are identical to those of the above-mentioned first embodiment are denoted by the same reference signs, and descriptions thereof are omitted.

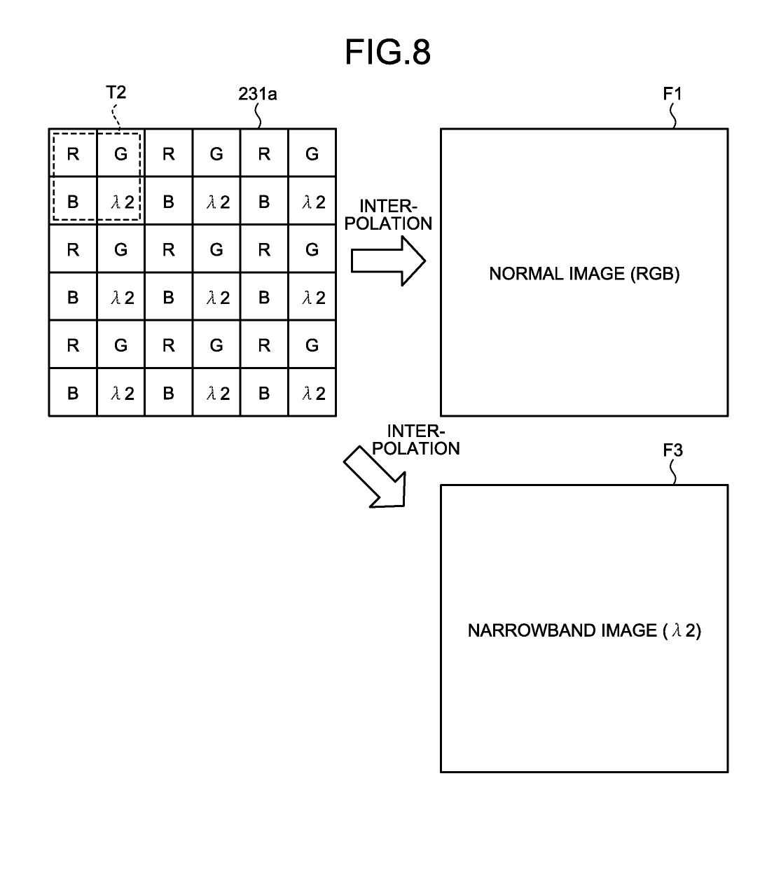

FIG. 8 is a diagram schematically illustrating the configuration of the color filter according to the third embodiment. As illustrated in FIG. 8, a color filter 231a is configured with the use of the color filter including a set of arrayed filters T2, that is, the broadband filter R that transmits the red component, the broadband filter G that transmits the green component, the broadband filter B that transmits the blue component, and a narrowband filter λ2 that transmits narrowband light having a maximum value of a transmission spectrum outside the range of the wavelength band of the light that passes through each of the broadband filters. As used herein, the wavelength band of the narrowband light in the third embodiment is an infrared region, and more preferably a near-infrared region. The image data generated by the imaging unit 23 using the color filter 231a configured as above are subjected to the predetermined image process by the receiving device 4 or the image processing device 5, and thus converted into the colored normal image F1 and an infrared narrowband image F3. Transmittance of each filter of the color filter 231a will be described later in detail.

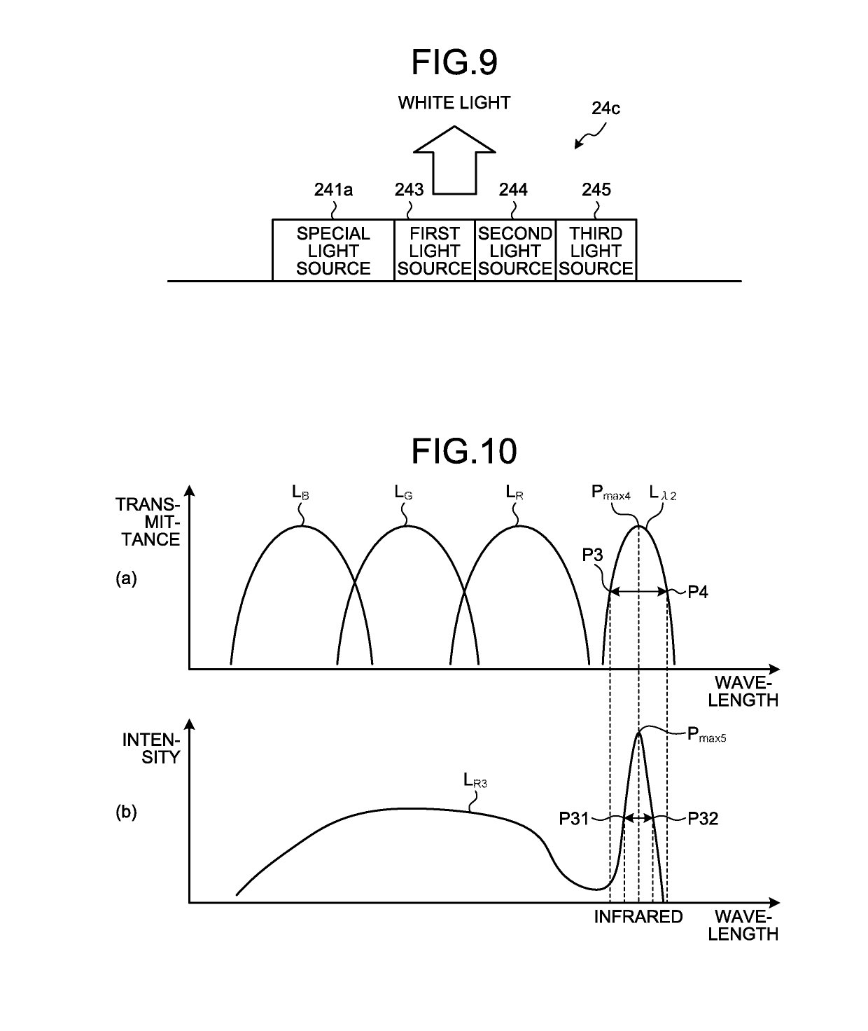

FIG. 9 is a schematic diagram illustrating the configuration of the light source unit according to the third embodiment. A light source unit 24c illustrated in FIG. 9 has a special light source 241a, the first light source 243, the second light source 244, and the third light source 245. The special light source 241a, the first light source 243, the second light source 244, and the third light source 245 are configured as a single light source module.

The special light source 241a emits light having a narrow spectrum with a maximum value in the infrared region. The special light source 241a is configured with the use of an LED light source.

The light source unit 24c configured as above radiates light including such first light that an upper limit value and a lower limit value of a wavelength that are half a maximum value in the light spectrum are between a lower limit value and an upper limit value of a wavelength that are half a maximum value in the transmission spectrum of the narrowband filter λ2 and second light having a maximum value of the light spectrum in a wavelength band different from the maximum value in the transmission spectrum that passes through the narrowband filter λ2.

Next, the relation between the transmittance of each filter that constitutes the above-mentioned color filter 231a and intensity of the light radiated by the light source unit 24c will be described. FIG. 10 is a diagram illustrating the relation between the transmittance of each filter that constitutes the color filter 231a and the intensity of the light radiated by the light source unit 24c. In FIG. 10, FIG. 10(a) illustrates the relation between the transmittance and the wavelength of each filter that constitutes the color filter 231a, and FIG. 10(b) illustrates the relation between the wavelength and the intensity of the light spectrum radiated by the light source unit 24c. In FIG. 10(a), the curve L_{B} illustrates the relation between the transmittance and the wavelength of the filter B, the curve L_{G} illustrates the relation between the transmittance and the wavelength of the filter G, the curve L_{R} illustrates the relation between the transmittance and the wavelength of the filter R, and a curve L_{λ2} illustrates the relation between the transmittance and the wavelength of the narrowband filter λ2. Moreover, in FIG. 10(b), a curve L_{R3} illustrates the relation between the intensity and the wavelength of the light radiated by the light source unit 24c.

As illustrated by the curve L_{R3} in FIG. 10, the light source unit 24c radiates such first light that an upper limit value P32 and a lower limit value P31 of the wavelength that are half a maximum value Pₘₐₓ₅ in the light spectrum are between a lower limit value P3 and an upper limit value P4 of the wavelength that are half a maximum value Pₘₐₓ₄ in the transmission spectrum of the narrowband filter λ2. More specifically, the light source unit 24c radiates such first light that both the lower limit value P31 and the upper limit value P32 of the wavelength that are half the maximum value Pₘₐₓ₅ in the light spectrum are between the lower limit value P3 and the upper limit value P4 of the wavelength that are half the maximum value Pₘₐₓ₄ in the transmission spectrum of the narrowband filter λ2. Moreover, the light source unit 24c radiates such first light that the maximum value Pₘₐₓ₅ of the narrow spectrum emitted by the special light source 241a of the light source unit 24c coincides with the maximum value Pₘₐₓ₄ of the transmission spectrum of the narrowband filter λ2. Furthermore, the light source unit 24c radiates the second light having the maximum value of the light spectrum in a wavelength band different from the maximum value Pₘₐₓ₅ of the transmission spectrum that passes through the narrowband filter λ2. More specifically, the light source unit 24c emits the second light having the maximum value of the light spectrum outside the maximum value Pₘₐₓ₄ of the transmission spectrum of the narrowband filter λ2.

According to the above-described third embodiment, the light source unit 24c radiates the light including such first light that the upper limit value and the lower limit value of the wavelength that are half the maximum value in the light spectrum are between the lower limit value and the upper limit value of the wavelength that are half the maximum value in the transmission spectrum of the narrowband filter λ2 and the second light having the maximum value of the light spectrum in the wavelength band different from the maximum value of the transmission spectrum that passes through the narrowband filter λ2. Therefore, the high-quality infrared narrowband image can be acquired.

In addition, according to the third embodiment, the light source unit 24c radiates such first light that the maximum value Pₘₐₓ₅ of the narrow spectrum emitted by the special light source 241a coincides with the maximum value Pₘₐₓ₄ of the transmission spectrum of the narrowband filter λ2. Therefore, the infrared narrowband image of higher quality can be acquired.

### Another Embodiment

In the present invention, the color filter includes the primary color filters. Alternatively, for example, complementary color filters (Cy, Mg, and Ye) that transmit beams of light having complementary wavelength components may be used. Moreover, a color filter (R, G, B, Or, and Cy) including the primary color filters and filters (Or and Cy) that transmit beams of light having wavelength components of orange and cyan may be used as the color filter. Furthermore, a color filter (R, G, B, and W) including the primary color filters and a filter (W) that transmits light having a wavelength component of white may be used.

In the present invention, the narrowband filter that transmits a single kind of wavelength band is provided in the color filter. Alternatively, a plurality of narrowband filters may be provided in the color filter. For example, the narrowband filter λ1 of the above-mentioned first embodiment and the narrowband filter λ2 of the above-mentioned third embodiment may be provided.

In the present invention, the capsule endoscope is described as an example of an imaging device. The present invention can also be applied to an endoscope having an insertion portion that is inserted into a subject.

According to the present disclosure, a high-quality narrowband image may be obtained even when a normal color image and the narrowband image are simultaneously shot.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An imaging system comprising:
an imaging sensor configured to perform a photoelectric conversion on light received by each of a plurality of pixels arranged in a grid pattern to generate an electric signal;
a color filter in which a filter unit including a plurality of first band filters and a second band filter is arranged in association with the plurality of pixels, each of the first band filters being configured to transmit light in a wavelength band of a primary color or a complementary color, the second band filter being configured to transmit narrowband light having a maximum value of a transmission spectrum outside a range of the wavelength band of the light that passes through the first band filter; and
a light source unit configured to radiate light having a projecting distribution in which at least one of an upper limit value and a lower limit value of a wavelength that are half a maximum value in a light spectrum of a light source is between an upper limit value and a lower limit value of a wavelength that are half the maximum value in the transmission spectrum of the second band filter, wherein
both a color image and a narrowband image are generated from a single image corresponding to the electric signal captured and output by the imaging sensor while the light source unit radiates the light.

2. The imaging system according to claim 1, wherein
the light source unit includes an LED light source, and
the LED light source radiates:
first light in which an upper limit value and a lower limit value of a wavelength that are half a maximum value in a light spectrum of the light source are between the lower limit value and the upper limit value of the wavelength that are half the maximum value in the transmission spectrum of the second band filter; and
second light having a maximum value of a light spectrum of a light source in a wavelength band different from the maximum value of the transmission spectrum of the second band filter.

3. The imaging system according to claim 1, further comprising:
an imaging device including the imaging sensor, the color filter, and the light source unit; and
a device configured to generate both of the color image and the narrowband image, wherein
the imaging device wirelessly sends the single image to the device.

4. The imaging system according to claim 3, wherein
the imaging system is a capsule endoscope system, and
the imaging device is a capsule endoscope.

5. The imaging system according to claim 4, wherein
the LED light source is configured by a single light source module and radiates the first light and the second light.
